(19) United States
(12) Patent Application Publication
(10) Pub. No.: US 2014/0334816 A1
(43) Pub. Date: Nov. 13, 2014

(54) METHOD, APPARATUS, AND SYSTEM FOR PROCESSING DATA ON OTN OPTICAL TRANSPORT NETWORK

(71) Applicant: Huawei Technologies Co., Ltd., Shenzhen (CN)

(72) Inventors: Jincan GUO, Shenzhen (CN); Zhangwei LEI, Chengdu (CN)

(73) Assignee: Huawei Technologies Co., Ltd., Shenzhen (CN)

(21) Appl. No.: 14/276,681

(22) Filed: May 13, 2014

(30) Foreign Application Priority Data
May 13, 2013 (CN) 201310174886.7

(51) Int. Cl. H04Q 11/00

(52) U.S. Cl. CPC H04Q 11/0003; H04Q 11/0066; H04Q 2011/0073
USPC 398/45

(57) ABSTRACT

A method for processing data on an OTN optical transport network is disclosed in embodiments of the present invention, including: receiving and buffering, through an ILK interface, an Ethernet data frame sent by an Ethernet board; encapsulating the Ethernet data frame into a Generic Framing Procedure GFP data frame; and mapping the GFP data frame to a virtual container of the OTN to form an OTN data frame, and transporting the OTN data frame to a corresponding transparent transmission board through a cross-connect board. An apparatus and a system for processing data on an OTN optical transport network are further disclosed in the embodiments of the present invention.

### CROSS-REFERENCE TO RELATED APPLICATION

This application claims priority to Chinese Patent Application No. 201310174886.7, filed on May 13, 2013, which is hereby incorporated by reference in its entirety.

### TECHNICAL FIELD

The present invention relates to the field of communications, and in particular, to a method, an apparatus, and a system for processing data on an OTN optical transport network.

### BACKGROUND

In an existing product, an Ethernet board does not support an OTN (Optical Transport Network, optical transport network, OTN for short) service processing function, and can transmit an input ETH (Ethernet, Ethernet, ETH for short) service on an OTN channel only after encapsulating the input Ethernet service.

In the prior art, a solution for interconnecting between an Ethernet board and a transparent transmission board is as follows:

Transparent transmission board A must be added for an Ethernet board to interconnect with transparent transmission board B. Transparent transmission board A encapsulates an ETH service into an OTN granule and sends the encapsulated ETH service to transparent transmission board B in a cross-connect manner by using a cross-connect board. Transparent transmission board B demaps the encapsulated ETH service from the OTN and transmits the ETH service to a line. When there are a large number of transparent transmission boards B, a large number of ETH interfaces need to be set for an Ethernet board. For example, if there are four transparent transmission boards B, each with 10 GE (Gigabit Ethernet, Gigabit Ethernet, GE for short) interfaces, the Ethernet board needs to support 40 GE interfaces. This greatly increases the complexity of Ethernet board interface design and increases the costs.

### SUMMARY

The objective problem of the present invention is to provide a method, an apparatus, and a system for processing data on an OTN optical transport network, which can solve the problems of the design complexity and high costs caused by excessive interfaces on an Ethernet board in the prior art.

To solve the technical problems, a first aspect of the present invention provides a method for processing data on an OTN optical transport network, including:

receiving and buffering, through an ILK interface, an Ethernet data frame sent by an Ethernet board;

encapsulating the Ethernet data frame into a Generic Framing Procedure GFP data frame; and

mapping the GFP data frame to a virtual container of the OTN to form an OTN data frame and transporting the OTN data frame to a corresponding transparent transmission board through a cross-connect board.

In a first possible implementation manner, the step of encapsulating the Ethernet data frame into a Generic Framing Procedure GFP data frame includes:

determining values of a PLI (PDU Length Indicator, frame length indicator, PLI for short) and cHEC (core Header Error Check, core Header Error Check, cHEC for short) according to a length of the Ethernet data frame and generating a core header of the GFP data frame; and

identifying a preamble and a frame delimiter of the Ethernet data frame, removing the preamble and the frame delimiter from the Ethernet data frame, and encapsulating the Ethernet data frame, of which the preamble and the frame delimiter are removed, into a payload area of the GFP data frame.

With reference to the first possible implementation manner of the first aspect, in a second possible implementation manner, the method further includes:

performing double-byte hexadecimal XOR scrambling on data in the core header of the GFP data frame; and

performing X43+1 polynomial self-synchronous scrambling on data in the payload area of the GFP data frame.

With reference to the first aspect, in a third possible implementation manner, the method further includes:

controlling a transmission rate of the Ethernet data frame according to a preset rate threshold.

With reference to the third possible implementation manner of the first aspect, in a fourth possible implementation manner, the step of controlling a transmission rate of the Ethernet data frame according to a preset rate threshold includes:

using a DIC algorithm to control the transmission rate of the Ethernet data frame.

A second aspect of the present invention provides a method for processing data on an OTN optical transport network, including:

receiving an OTN data frame transmitted, through a cross-connect board, by a transparent transmission board;

demapping the OTN data frame to form a GFP data frame and decapsulating the GFP data frame to restore an Ethernet data frame; and

buffering the Ethernet data frame and sending the Ethernet data frame to an Ethernet board through an ILK interface.

In a first possible implementation manner, the method further includes:

identifying a preamble and an interframe gap of the Ethernet data frame and stripping off the preamble and the interframe gap from the Ethernet data frame.

A third aspect of the present invention provides an apparatus for processing data on an OTN optical transport network, including:

a receiving and buffering module, configured to receive and buffer, through an ILK interface, an Ethernet data frame sent by an Ethernet board;

a GFP frame encapsulating module, configured to encapsulate the Ethernet data frame into a Generic Framing Procedure GFP data frame; and

a mapping and sending module, configured to map the GFP data frame to a virtual container of the OTN to form an OTN data frame and transport the OTN data frame to a corresponding transparent transmission board through a cross-connect board.

In a first possible implementation manner, the GFP frame encapsulating module includes:

a core header generating unit, configured to determine values of a PLI and cHEC according to a length of the Ethernet data frame and generate a core header of the GFP data frame; and

a payload area generating unit, configured to identify a preamble and a frame delimiter of the Ethernet data frame, remove the preamble and the frame delimiter from the Ethernet data frame, and encapsulate the Ethernet data frame, of which the preamble and the frame delimiter are removed, into a payload area of the GFP data frame.

With reference to the first possible implementation manner of the third aspect, in a second possible implementation manner, the apparatus further includes:

a scrambling module, configured to perform double-byte hexadecimal XOR scrambling on data in the core header of the GFP data frame and perform X43+1 polynomial self-synchronous scrambling on data in the payload area of the GFP data frame.

With reference to the third aspect, in a third possible implementation manner, the apparatus further includes:

a rate controlling module, configured to control a transmission rate of the Ethernet data frame according to a preset rate threshold.

With reference to the third possible implementation manner of the third aspect, in a fourth possible implementation manner, the rate controlling module is configured to use a DIC algorithm to control the transmission rate of the Ethernet data frame.

A fourth aspect of the present invention provides an apparatus for processing data on an OTN optical transport network, including:

a data frame receiving module, configured to receive an OTN data frame transmitted, through a cross-connect board, by a transparent transmission board;

a demapping and decapsulating module, configured to demap the OTN data frame to form a GFP data frame and decapsulate the GFP data frame to restore an Ethernet data frame; and

a buffering and sending module, configured to buffer the Ethernet data frame and send the Ethernet data frame to an Ethernet board through an ILK interface.

In a first possible implementation manner, the apparatus further includes:

a stripping module, configured to identify a preamble and an interframe gap of the Ethernet data frame and strip off the preamble and the interframe gap from the Ethernet data frame.

A fifth aspect of the present invention provides a system for processing data on an OTN optical transport network, including an Ethernet board, a transparent transmission board, a cross-connect board, and any one of the foregoing processing apparatuses.

The embodiments of the present invention have the following beneficial effects:

An Ethernet data frame transmitted by an Ethernet board through an ILK interface is encapsulated into a GFP data frame, the GFP data frame is mapped to a virtual container to form an OTN data frame, and then the OTN data frame is transported to a corresponding transparent transmission board through a cross-connect board. By setting the ILK interface, the number of interfaces on the Ethernet board can be reduced effectively, and the system design complexity is reduced and the costs are saved.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic flowchart of a method for processing data on an OTN optical transport network according to a first embodiment of the present invention;

FIG. 2 is a schematic flowchart of a method for processing data on an OTN optical transport network according to a second embodiment of the present invention;

FIG. 3 is a schematic structural diagram of an apparatus for processing data on an OTN optical transport network according to the first embodiment of the present invention;

FIG. 4 is a schematic structural diagram of an apparatus for processing data on an OTN optical transport network according to the second embodiment of the present invention;

FIG. 5 is a schematic structural diagram of a GFP frame encapsulating module shown in FIG. 4;

FIG. 6 is a schematic structural diagram of an apparatus for processing data on an OTN optical transport network according to a third embodiment of the present invention;

FIG. 7 is a schematic flowchart of a method for processing data on an OTN optical transport network according to the third embodiment of the present invention;

FIG. 8 is a schematic structural diagram of an apparatus for processing data on an OTN optical transport network according to a fourth embodiment of the present invention;

FIG. 9 is a schematic structural diagram of an apparatus for processing data on an OTN optical transport network according to a fifth embodiment of the present invention; and

FIG. 10 is a schematic structural diagram of a system for processing data on an OTN optical transport network according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

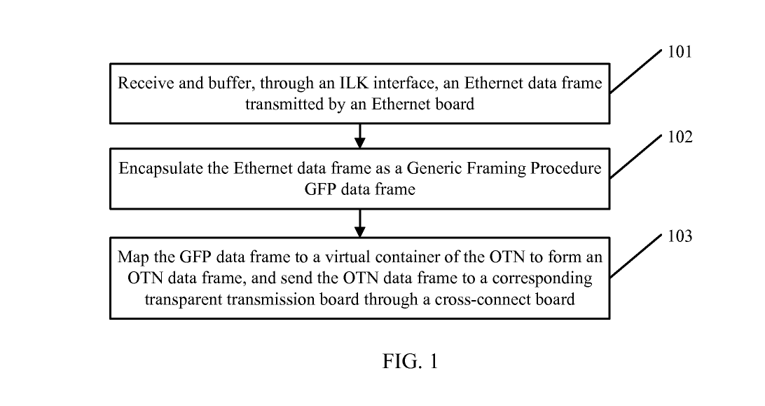

FIG. 1 is a schematic flowchart of a method for processing data on an OTN optical transport network according to a first embodiment of the present invention. The method includes:

Step 101: Receive and buffer, through an ILK (Interlaken, ILK for short) interface, an Ethernet data frame sent by an Ethernet board.

Specifically, a processing apparatus receives, through an ILK interface set by the processing apparatus, an Ethernet data frame sent by an Ethernet board, and an ILK interface is also set for an output port of the Ethernet board to transmit data to the ILK interface of the processing apparatus. An Interlaken protocol is a new-generation packet interconnectprotocol, and has a capability of running for different quantities of channels, thereby achieving expansibility. For example, an ILK interface with a bandwidth of 100 Gbps may be expanded into 10 channels of 10 Gbps to connect to 10 Ethernet interfaces with a bandwidth of 10 Gbps, or expanded into 5 channels of 20 Gbps to connect to 5 Ethernet interfaces with a bandwidth of 20 Gbps, or expanded into a mixture of 4 channels of 10 Gbps, 1 channel of 20 Gbps, and 1 channel of 40 Gbps to connect to a corresponding number of Ethernet interfaces. The flexible configuration greatly reduces the number of interfaces set for an Ethernet board and a processing apparatus, thereby reducing the system design complexity.

Step 102: Encapsulate the Ethernet data frame into a GFP (Generic Framing Procedure, Generic Framing Procedure, GFP for short) data frame.

Step 103: Map the GFP data frame to a virtual container of the OTN to form an OTN data frame, and transport the OTN data frame to a corresponding transparent transmission board through a cross-connect board.

In implementation of the embodiment of the present invention, an Ethernet data frame transmitted by an Ethernet board through an ILK interface is encapsulated into a GFP data frame, the GFP data frame is mapped to a virtual container to form an OTN data frame, and then the OTN data frame is transported to a corresponding transparent transmission board through a cross-connect board. By setting the ILK interface, the number of interfaces on the Ethernet board can be reduced effectively, and the system design complexity is reduced and the costs are saved.

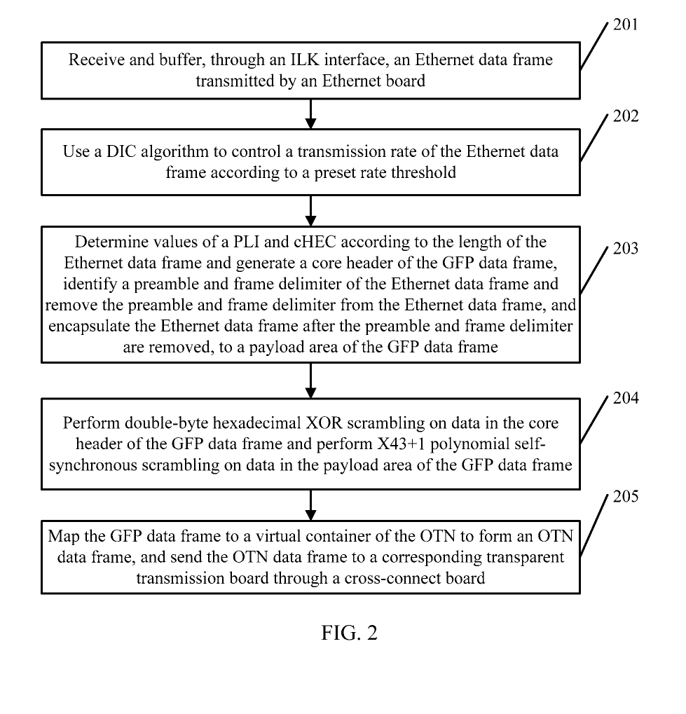

FIG. 2 is a schematic flowchart of a method for processing data on an OTN optical transport network according to a second embodiment of the present invention. The method includes:

Step 201: Receive and buffer, through an ILK interface, an Ethernet data frame sent by an Ethernet board.

Specifically, Interlaken is an interconnect protocol optimized for implementing high-bandwidth and reliable packet transmission. The protocol uses multiple serial links to establish a logical connection between devices, and uses a multi-channel, back pressure capability, and data integrity protection to improve performance of communication devices. In the embodiment of the present invention, the protocol can effectively reduce the number of interfaces on the Ethernet board and increase flexibility of an Ethernet board access service.

Step 202: Use a DIC algorithm to control a transmission rate of the Ethernet data frame according to a preset rate threshold.

Specifically, due to a burstiness feature of an Ethernet data frame transmitted through an ILK interface, when a transmission rate of the Ethernet data frame sent by an Ethernet board is beyond a processing capability of a processing apparatus, loss of the Ethernet data frame is caused. Therefore, the processing apparatus needs to limit the transmission rate of the Ethernet data frame, and a method is using the DIC algorithm to control the transmission rate of the Ethernet data frame according to the preset rate threshold. It can be understood that, the transmission rate is controlled according to the preset rate threshold. Understandably, other methods may also be used to control the transmission rate of the Ethernet data frame, for example, inserting an idle bit into the Ethernet data frame, which is not limited in the present invention.

Step 203: Determine values of a PLI and cHEC according to a length of the Ethernet data frame and generate a core header of the GFP data frame, identify a preamble and a frame delimiter of the Ethernet data frame and remove the preamble and the frame delimiter from the Ethernet data frame, and encapsulate the Ethernet data frame, of which the preamble and the frame delimiter are removed, into a payload area of the GFP data frame.

Specifically, the GFP data frame is formed by a core header and a payload area. The value of the PLI (PDU Length Indicator, frame length indicator, PLI for short) is determined according to the length of the Ethernet data frame. By performing the CRC (Cyclical Redundancy Check, cyclical redundancy check, CRC for short) on the value of the PLI, the value of the cHEC (core Head Error Check, core header error check, cHEC for short) is obtained. The core header of the GFP data frame is constructed according to the values of the PLI and cHEC. The preamble is formed by a bit sequence 101010 . . . 1010 of 56 bits (7 bytes). The frame delimiter is formed by 8 bits (1 byte), and a bit sequence of the frame delimiter is usually 10101011. The preamble and the frame delimiter are mainly used for synchronizing reception. When the Ethernet data frame is to be encapsulated into the GFP data frame, the Ethernet data frame needs to be encapsulated into the payload area of the GFP data frame after the preamble and the frame delimiter of the Ethernet data frame are removed.

Step 204: Perform double-byte hexadecimal XOR scrambling on data in the core header of the GFP data frame and perform X43+1 polynomial self-synchronous scrambling on data in the payload area of the GFP data frame.

Specifically, scrambling is performed on the data in the core header and payload area of the GFP data frame to increase GFP data frame transmission reliability, and descrambling is also required at a receiving end.

Step 205: Map the GFP data frame to a virtual container of the OTN to form an OTN data frame, and transport the OTN data frame to a corresponding transparent transmission board through a cross-connect board.

In implementation of the embodiment of the present invention, an Ethernet data frame transmitted by an Ethernet board through an ILK interface is encapsulated into a GFP data frame, the GFP data frame is mapped to a virtual container to form an OTN data frame, and then the OTN data frame is transported to a corresponding transparent transmission board through a cross-connect board. By setting the ILK interface, the number of interfaces on the Ethernet board can be reduced effectively, and the system design complexity is reduced and the costs are saved.

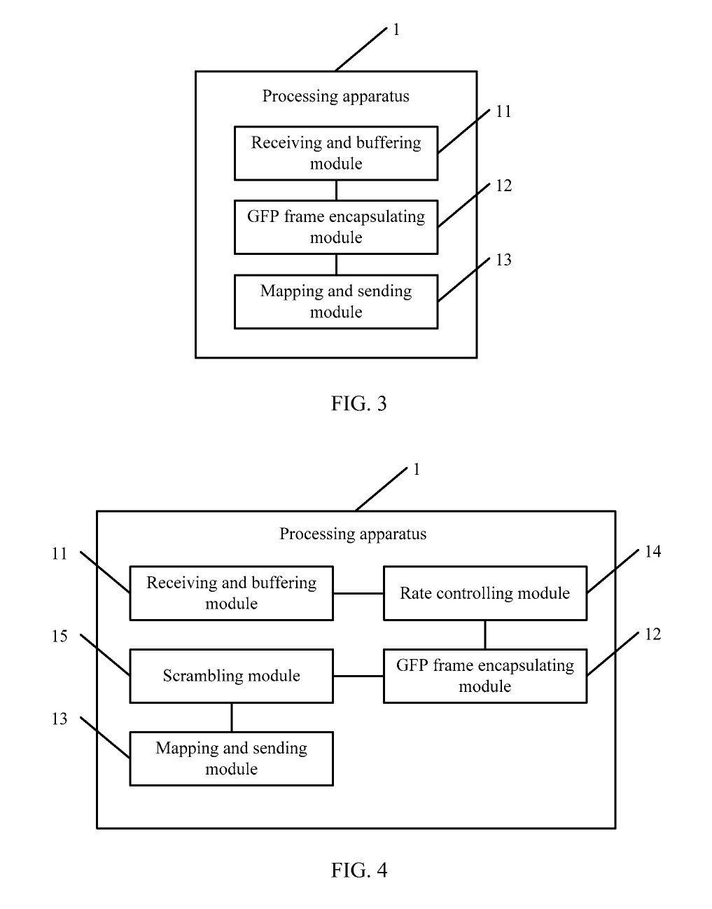

FIG. 3 is a first schematic structural diagram of an apparatus for processing data on an OTN optical transport network according to an embodiment of the present invention. The apparatus is briefly referred to as a processing apparatus 1 in the following. The processing apparatus 1 includes:

a receiving and buffering module 11, configured to receive and buffer an Ethernet data frame sent by an Ethernet board;

a GFP frame encapsulating module 12, configured to encapsulate the Ethernet data frame into a Generic Framing Procedure GFP data frame; and

a mapping and sending module 13, configured to map the GFP data frame to a virtual container of the OTN to form an OTN data frame and transport the OTN data frame to a corresponding transparent transmission board through a cross-connect board.

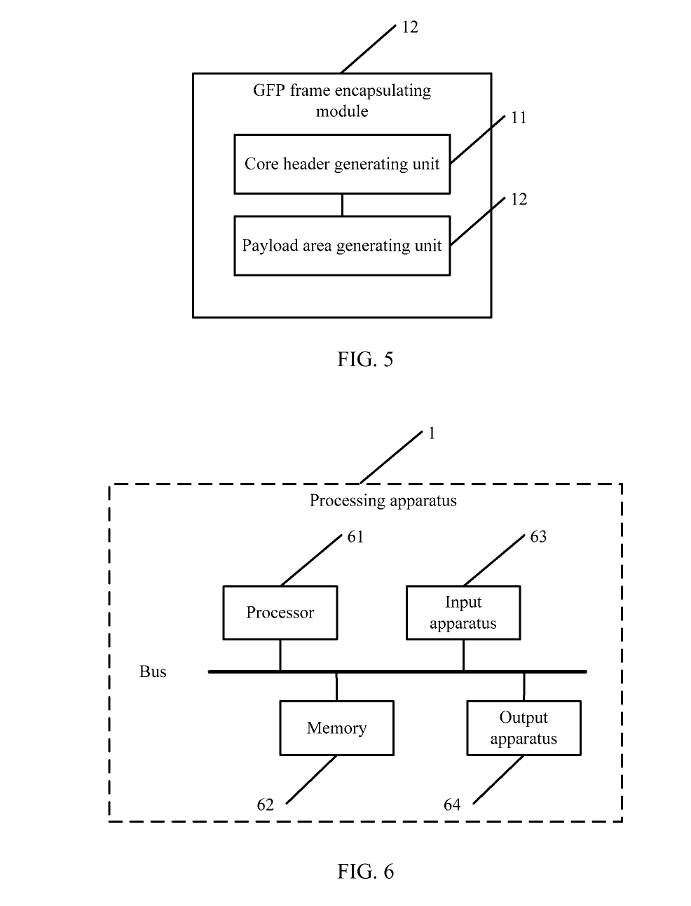

FIG. 4 and FIG. 5 are second schematic structural diagrams of an apparatus for processing data on an OTN optical transport network according to an embodiment of the present invention. In addition to the receiving and buffering module 11, the GFP frame encapsulating module 12, and the mapping and sending module 13, the processing apparatus 1 further includes:

a rate controlling module 14, configured to control a transmission rate of the Ethernet data frame according to a preset rate threshold; where specifically, the rate controlling module 14 uses a DIC algorithm to control the transmission rate of the Ethernet data frame according to the preset rate threshold. Understandably, the rate controlling module 14 may also use other methods to control the transmission rate of the Ethernet data frame, for example, inserting an idle bit into the Ethernet data frame, which is not limited in the present invention; and

a scrambling module 15 configured to perform double-byte hexadecimal XOR scrambling on data in a core header of the GFP data frame and perform X43+1 polynomial self-synchronous scrambling on data in a payload area of the GFP data frame.

Specifically, the scrambling module 15 performs scrambling on the data in the core header and payload area of the GFP data frame to increase GFP data frame transmission reliability, and descrambling is also required at a receiving end.

The GFP frame encapsulating module 12 includes:

a core header generating unit 121, configured to determine values of a PLI and cHEC according to a length of the Ethernet data frame and generate the core header of the GFP data frame; and

a payload area generating unit 122, configured to identify a preamble and a frame delimiter of the Ethernet data frame, remove the preamble and the frame delimiter from the Ethernet data frame, and encapsulate the Ethernet data frame, of which the preamble and the frame delimiter are removed, into the payload area of the GFP data frame.

In implementation of the embodiment of the present invention, an Ethernet data frame transmitted by an Ethernet board through an ILK interface is encapsulated into a GFP data frame, the GFP data frame is mapped to a virtual container to form an OTN data frame, and then the OTN data frame is transported to a corresponding transparent transmission board through a cross-connect board. By setting the ILK interface, the number of interfaces on the Ethernet board can be reduced effectively, and the system design complexity is reduced and the costs are saved.

FIG. 6 is a third schematic structural diagram of an apparatus for processing data on an OTN optical transport network according to the present invention. The processing apparatus includes a processor 61, a memory 62, an input apparatus 63, and an output apparatus 64. There may be one or more processors 61 in the processing apparatus 1, and FIG. 6 uses one processor as an example. In some embodiments of the present invention, the processor 61, memory 62, input apparatus 63, and output apparatus 64 may be connected by a bus or in other manners, and FIG. 6 uses bus connection as an example.

The memory 62 stores a set of program code, and the processor 61 is configured to invoke the program code stored in the memory 62 to perform the following operations:

receive and buffer, through an ILK interface, an Ethernet data frame sent by an Ethernet board;

encapsulate the Ethernet data frame into a Generic Framing Procedure GFP data frame; and

map the GFP data frame to a virtual container of the OTN to form an OTN data frame, and transport the OTN data frame to a corresponding transparent transmission board through a cross-connect board.

In some embodiments of the present invention, the processor 61 is further configured to:

control a transmission rate of the Ethernet data frame according to a preset rate threshold.

Preferably, in some embodiments of the present invention, the processor 61 is configured to:

use a DIC algorithm to control the transmission rate of the Ethernet data frame.

Preferably, in some embodiments of the present invention, the processor 61 is configured to:

perform double-byte hexadecimal XOR scrambling on data in a core header of the GFP data frame; and

perform X43+1 polynomial self-synchronous scrambling on data in a payload area of the GFP data frame.

Preferably, in some embodiments of the present invention, the processor 61 is configured to:

determine values of a PLI and cHEC according to a length of the Ethernet data frame and generate the core header of the GFP data frame; and

identify a preamble and a frame delimiter of the Ethernet data frame, remove the preamble and the frame delimiter from the Ethernet data frame, and encapsulate the Ethernet data frame, of which the preamble and the frame delimiter are removed, into the payload area of the GFP data frame.

In implementation of the embodiment of the present invention, an Ethernet data frame transmitted by an Ethernet board through an ILK interface is encapsulated into a GFP data frame, the GFP data frame is mapped to a virtual container to form an OTN data frame, and then the OTN data frame is transported to a corresponding transparent transmission board through a cross-connect board. By setting the ILK interface, the number of interfaces on the Ethernet board can be reduced effectively, and the system design complexity is reduced and the costs are saved.

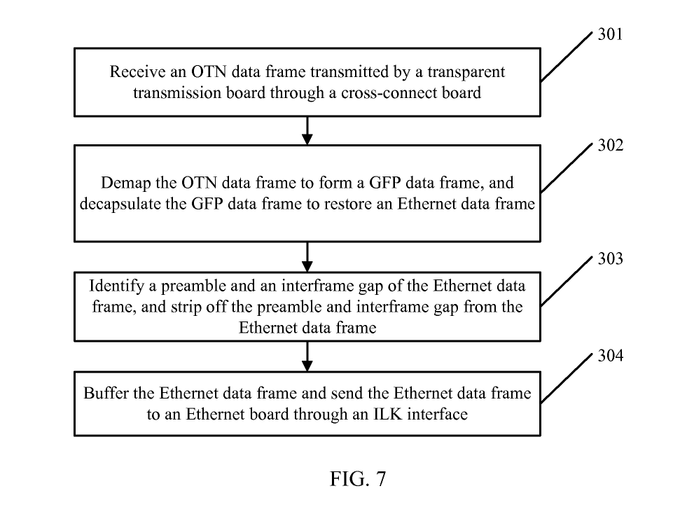

FIG. 7 is another schematic flowchart of a method for processing data on an OTN optical transport network according to an embodiment of the present invention. The method includes:

Step 301: Receive an OTN data frame transmitted, through a cross-connect board, by a transparent transmission board.

Step 302: Demap the OTN data frame to form a GFP data frame, and decapsulate the GFP data frame to restore an Ethernet data frame.

Step 303: Identify a preamble and an interframe gap of the Ethernet data frame, and strip off the preamble and the interframe gap from the Ethernet data frame.

Step 304: Buffer the Ethernet data frame and send the Ethernet data frame to an Ethernet board through an ILK interface.

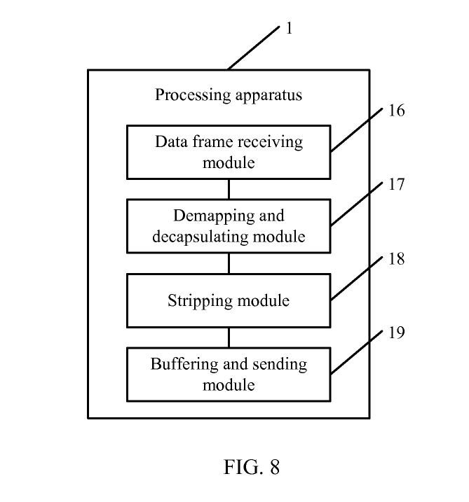

FIG. 8 is a fourth schematic structural diagram of an apparatus for processing data on an OTN optical transport network according to an embodiment of the present invention. The processing apparatus includes:

a data frame receiving module 16, configured to receive an OTN data frame transmitted, through a cross-connect board, by a transparent transmission board;

a demapping and decapsulating module 17, configured to demap the OTN data frame to form a GFP data frame and decapsulate the GFP data frame to restore an Ethernet data frame;

a stripping module 18, configured to identify a preamble and an interframe gap of the Ethernet data frame and strip off the preamble and the interframe gap from the Ethernet data frame; and

a buffering and sending module 19, configured to buffer the Ethernet data frame and send the Ethernet data frame to an Ethernet board through an ILK interface.

In implementation of the embodiment of the present invention, an Ethernet data frame transmitted by an Ethernet board through an ILK interface is encapsulated into a GFP data frame, the GFP data frame is mapped to a virtual container to form an OTN data frame, and then the OTN data frame is transported to a corresponding transparent transmission board through a cross-connect board. By setting the ILK interface, the number of interfaces on the Ethernet board can be reduced effectively, and the system design complexity is reduced and the costs are saved.

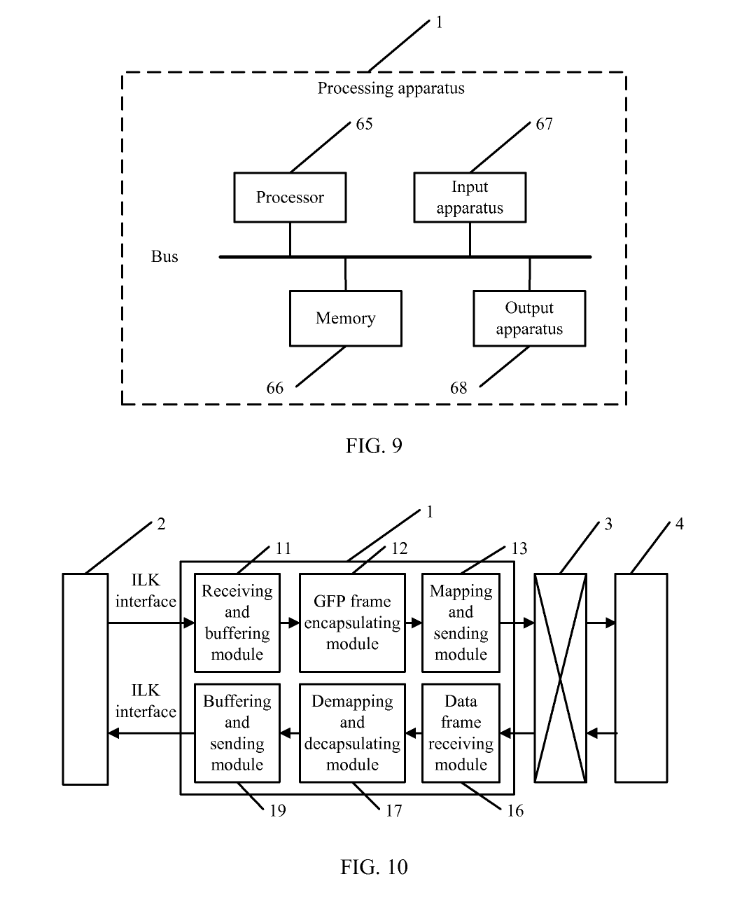

FIG. 9 is a fifth schematic structural diagram of an apparatus for processing data on an OTN optical transport network according to an embodiment of the present invention. The processing apparatus includes a processor 65, a memory 66, an input apparatus 67, and an output apparatus 68. There may be one or more processors 65 in the processing apparatus 1, and FIG. 9 uses one processor as an example. In some embodiments of the present invention, the processor 65, the memory 66, the input apparatus 67, and the output apparatus 68 may be connected by a bus or in other manners, and FIG. 9 uses bus connection as an example.

The memory 66 stores a set of program code, and processor 65 is configured to invoke the program code stored in the memory 66 to perform the following operations:

a data frame receiving module, configured to receive an OTN data frame transmitted, through a cross-connect board, by a transparent transmission board;

a demapping and decapsulating module, configured to demap the OTN data frame to form a GFP data frame and decapsulate the GFP data frame to restore an Ethernet data frame; and

a buffering and sending module, configured to buffer the Ethernet data frame and send the Ethernet data frame to an Ethernet board through an ILK interface.

In some embodiments of the present invention, the processor 65 is further configured to identify a preamble and an interframe gap of the Ethernet data frame and strip off the preamble and the interframe gap from the Ethernet data frame.

Preferably, in some embodiments of the present invention, the processor 65 is configured to buffer the Ethernet data frame and send the Ethernet data frame to an Ethernet board through an ILK interface.

In implementation of the embodiment of the present invention, an OTN data frame transmitted by a transparent transmission board is demapped and decapsulated to restore an Ethernet data frame, so that the Ethernet data frame can be directly sent to an Ethernet board through a cross-connect board and that the number of interfaces on the Ethernet board is reduced. This overcomes the problem that an Ethernet board and a transparent transmission board cannot interconnect directly and have poor compatibility in the prior art.

FIG. 10 is a schematic structural diagram of a system for processing data on an OTN optical transport network according to an embodiment of the present invention. The system includes an Ethernet board 2, a processing apparatus 1, a cross-connect board 3, and a transparent transmission board 4. A working process is as follows:

When the Ethernet board 2 sends an Ethernet data frame to the transparent transmission board 4 through an ILK interface, a receiving and buffering module 11 receives and buffers the Ethernet data frame sent by the Ethernet board; a GFP frame encapsulating module 12 encapsulates the Ethernet data frame into a Generic Framing Procedure GFP data frame; and a mapping and sending module 13 maps the GFP data frame to a virtual container of the OTN to form an OTN data frame and transports the OTN data frame to the transparent transmission board 4 through the cross-connect board 3.

When the Ethernet board 2 receives, through the ILK interface of the Ethernet board 2, an OTN data frame sent by the transparent transmission board 4, a data frame receiving module 16 receives the OTN data frame sent by the transparent transmission board 4 through the cross-connect board 3; a demapping and decapsulating module 17 demaps the OTN data frame to form a GFP data frame and decapsulates the GFP data frame to restore an Ethernet data frame; and a buffering and sending module 19 buffers the Ethernet data frame and sends the Ethernet data frame to the ILK interface of the Ethernet board.

In implementation of the embodiment of the present invention, an Ethernet data frame transmitted by an Ethernet board through an ILK interface is encapsulated into a GFP data frame, the GFP data frame is mapped to a virtual container to form an OTN data frame, and then the OTN data frame is transported to a corresponding transparent transmission board through a cross-connect board. By setting the ILK interface, the number of interfaces on the Ethernet board can be reduced effectively, and the system design complexity is reduced and the costs are saved.

A person of ordinary skill in the art may understand that all or a part of the processes of the methods in the embodiments may be implemented by a computer program instructing relevant hardware. The program may be stored in a computer readable storage medium. When the program runs, the processes of the methods in the embodiments are performed. The storage medium may be a magnetic disk, an optical disc, a read-only memory (Read-Only Memory, ROM), or a random access memory (Random Access Memory, RAM).

The foregoing disclosures are only exemplary embodiments of the present invention, and are not intended to limit the protection scope of the present invention. A person of ordinary skill in the art may understand and implement all or a part of the processes of the foregoing embodiments, and equivalent variations made according to the claims of the present invention shall still fall within the scope of the present invention.

1. A method for processing data on an optical transport network (OTN), the method comprising:
receiving and buffering, through an Interlaken (ILK) interface, an Ethernet data frame sent by an Ethernet board;
encapsulating the Ethernet data frame into a Generic Framing Procedure (GFP) data frame;
mapping the GFP data frame to a virtual container of the OTN to form an OTN data frame; and
transporting the OTN data frame to a corresponding transparent transmission board through a cross-connect board.

2. The method according to claim 1, wherein the step of encapsulating the Ethernet data frame comprises:
determining values of a PDU Length Indicator (PLI) and a core Header Error Check (cHEC) according to a length of the Ethernet data frame,
generating a core header of the GFP data frame, and
identifying a preamble and a frame delimiter of the Ethernet data frame,
removing the preamble and the frame delimiter from the Ethernet data frame, and
encapsulating the Ethernet data frame, of which the preamble and the frame delimiter are removed, into a payload area of the GFP data frame.

3. The method according to claim 2, further comprising:
performing double-byte hexadecimal XOR scrambling on data in the core header of the GFP data frame; and
performing X43+1 polynomial self-synchronous scrambling on data in the payload area of the GFP data frame.

4. The method according to claim 1, further comprising:
controlling a transmission rate of the Ethernet data frame according to a preset rate threshold.

5. The method according to claim 4, wherein the step of controlling the transmission rate of the Ethernet data frame according to the preset rate threshold comprises:
using a DIC algorithm to control the transmission rate of the Ethernet data frame.

6. A method for processing data on an optical transport network (OTN), the method comprising:
receiving, by a transparent transmission board, an OTN data frame transmitted through a cross-connect board;
demapping the OTN data frame to form a Generic Framing Procedure (GFP) data frame;
decapsulating the GFP data frame to restore an Ethernet data frame; and
buffering the Ethernet data frame and sending the Ethernet data frame to an Ethernet board through an Interlaken (ILK) interface.

7. The method according to claim 6, further comprising:
identifying a preamble and an interframe gap of the Ethernet data frame; and
stripping off the preamble and the interframe gap from the Ethernet data frame.

8. A processing apparatus for processing data on an optical transport network (OTN), the processing apparatus comprising:
a receiving and buffering module, configured to receive and buffer, through an Interlaken (ILK) interface, an Ethernet data frame sent by an Ethernet board through the ILK interface;
a Generic Framing Procedure (GFP) frame encapsulating module, configured to encapsulate the Ethernet data frame into a GFP data frame; and
a mapping and sending module, configured to map the GFP data frame to a virtual container of the OTN to form an OTN data frame and transport the OTN data frame to a corresponding transparent transmission board through a cross-connect board.

9. The processing apparatus according to claim 8, wherein the GFP frame encapsulating module comprises:
a core header generating unit, configured to determine values of a PDU Length Indicator (PLI) and a core Header Error Check (cHEC) according to a length of the Ethernet data frame and generate a core header of the GFP data frame; and
a payload area generating unit, configured to identify a preamble and a frame delimiter of the Ethernet data frame, remove the preamble and the frame delimiter from the Ethernet data frame, and encapsulate the Ethernet data frame, of which the preamble and the frame delimiter are removed, into a payload area of the GFP data frame.

10. The processing apparatus according to claim 9, further comprising:
a scrambling module, configured to perform double-byte hexadecimal XOR scrambling on data in the core header of the GFP data frame and perform X43+1 polynomial self-synchronous scrambling on data in the payload area of the GFP data frame.

11. The processing apparatus according to claim 8, further comprising:
a rate controlling module, configured to control a transmission rate of the Ethernet data frame according to a preset rate threshold.

12. The processing apparatus according to claim 11, wherein the rate controlling module uses a DIC algorithm to control the transmission rate of the Ethernet data frame.

13. A processing apparatus for processing data on an optical transport network (OTN), the processing apparatus comprising:
a data frame receiving module, configured to receive, by a transparent transmission board, an OTN data frame transmitted through a cross-connect board;
a demapping and decapsulating module, configured to demap the OTN data frame to form a Generic Framing Procedure (GFP) data frame and decapsulate the GFP data frame to restore an Ethernet data frame; and
a buffering and sending module, configured to buffer the Ethernet data frame and send the Ethernet data frame to an Ethernet board through an Interlaken (ILK) interface.

14. The processing apparatus according to claim 13, further comprising:
a stripping module, configured to identify a preamble and an interframe gap of the Ethernet data frame and strip off the preamble and the interframe gap from the Ethernet data frame.

15. A system for processing data on an optical transport network (OTN), the system comprising:
an Ethernet board,
a transparent transmission board,
a cross-connect board, and
a processing apparatus that includes:
a receiving and buffering module, configured to receive and buffer, through an Interlaken (ILK) interface, an Ethernet data frame sent by the Ethernet board through the ILK interface;
a Generic Framing Procedure (GFP) frame encapsulating module, configured to encapsulate the Ethernet data frame into a GFP data frame; and
a mapping and sending module, configured to map the GFP data frame to a virtual container of the OTN to form an OTN data frame and transport the OTN data frame to the transparent transmission board through the cross-connect board.
